(19) United States
(12) Patent Application Publication
(10) Pub. No.: US 2025/0181401 A1
(43) Pub. Date: Jun. 5, 2025

(54) ACCELERATOR OFFLOAD DEVICE, ACCELERATOR OFFLOAD SYSTEM AND ACCELERATOR OFFLOAD METHOD

(71) Applicant: Nippon Telegraph and Telephone Corporation, Tokyo (JP)

(72) Inventors: Kei FUJIMOTO, Musashino-shi, Tokyo (JP); Shogo SAITO, Musashino-shi, Tokyo (JP); Ikuo OTANI, Musashino-shi, Tokyo (JP); Ko NATORI, Musashino-shi, Tokyo (JP)

(21) Appl. No.: 18/842,930

(22) PCT Filed: Mar. 9, 2022
(86) PCT No.: PCT/JP2022/010422

§ 371 Date: Aug. 30, 2024

(51) Int. Cl. G06F 9/50

(52) U.S. Cl. CPC G06F 9/5027; G06F 2209/509

(57) ABSTRACT

An accelerator offload device that offloads specific processing of an application program to an accelerator includes: a request-related processing part; a request I/O part; a response I/O part; and a response-related processing part. The request-related processing part is configured to perform predetermined processing required before performing offloading to the accelerator and then notify the request I/O part of a request to perform offloading. The request I/O part is configured to operate on a first CPU core to perform request processing of notifying the accelerator of an offload request. The response I/O part is configured to operate on a second CPU core different from the first CPU core to perform response processing of notifying the response-related processing part of operation completion of the accelerator. The response-related processing part is configured to perform an operation described in the application program by using an operation result of the accelerator.

### CROSS-REFERENCE TO RELATED APPLICATIONS

This is a National Stage Application of PCT Application No. PCT/JP2022/010422, filed on Mar. 9, 2022. The disclosure of the prior application is considered part of the disclosure of this application, and is incorporated in its entirety into this application.

### BACKGROUND

### Technical Field

The present invention relates to an accelerator offload device, an accelerator offload system, and an accelerator offload method.

### Background Art

Workloads that processors are good at are different depending on the type of processor. Central processing units (CPUs) have high versatility, but are not good at operating a workload having a high degree of parallelism, whereas accelerators (hereinafter, appropriately referred to as ACCs), such as a field programmable gate array (FPGA)/(hereinafter, “/” means “or”) a graphics processing unit (GPU)/an application specific integrated circuit (ASIC), can operate the workload at high speed with high efficiency. Offload techniques, which improve overall operation time and operation efficiency by combining those different types of processors and offloading a workload that CPUs are not good at to ACCs to operate the workload, have been increasingly utilized.

Representative examples of a specific workload subjected to ACC offloading include encoding/decoding processing (forward error correction processing (FEC)) in a virtual radio access network (vRAN), audio and video media processing, and encryption/decryption processing.

FIG. 17 is a schematic diagram illustrating processing of offloading part of the processing to be operated by a CPU to an accelerator (ACC).

As illustrated in FIG. 17, an accelerator system includes hardware (HW) 10, an OS or the like 20, and an application (APL) 1 in a user space 30.

Hardware 10 includes a CPU 11 and an accelerator (ACC) 12.

ACC 12 is computing unit hardware that performs specific operation at high speed based on an input from CPU 11. Specifically, accelerator 12 is a GPU or a programmable logic device (PLD) such as an FPGA.

As indicated by the white arrow a in FIG. 17, part of processing by APL 1 (workload that CPU 11 is not good at) is offloaded to ACC 12, thereby achieving performance and power efficiency that cannot be achieved only by software (CPU processing).

Techniques of transferring data in a server include New API (NAPI), Data Plane Development Kit (DPDK), and Kernel Busy Poll (KBP).

New API (NAPI) performs, upon arrival of a packet, packet processing in response to a software interrupt request after a hardware interrupt request (see Non-Patent Literature 1).

DPDK implements a packet processing function in the user space in which applications operate and, when a packet arrives, immediately pulls the packet from the user space according to a polling model. Specifically, DPDK is a framework for performing control on a network interface card (NIC) in the user space, which has been conventionally performed by the Linux kernel (registered trademark). The largest difference from the processing by the Linux kernel is to have a polling-based reception mechanism called Pull Mode Driver (PMD). Normally, in the Linux kernel, an interrupt is generated upon arrival of data to the NIC, and reception processing is triggered by an interrupt. On the other hand, in PMD, a dedicated thread continuously performs checking data arrival and reception processing. PMD is capable of performing high-speed packet processing by eliminating overheads such as context switching and interrupts. DPDK greatly improves the performance and throughput of packet processing, thereby securing more time for data plane application processing. However, DPDK exclusively uses computer resources such as CPUs and NICs.

Patent Literature 1 discloses an in-server network delay control device (KBP). KBP constantly monitors packet arrivals according to a polling model in the kernel. This restrains softIRQ and achieves low-latency packet processing.

### CITATION LIST

### Patent Literature

Patent Literature 1: WO 2021/130828 A

### Non-Patent Literature

Non-Patent Literature 1: New API (NAPI), [online], [searched on Mar. 11, 2022], the Internet <URL: http://http://lwn.net/2002/0321/a/napi-howto.php3>

### SUMMARY OF THE INVENTION

### Technical Problem

Conventional methods of acquiring the operation result of an ACC in ACC offloading include a (1) interrupt method and a (2) polling method.

In the (1) interrupt method, an application detects completion of the operation via an interrupt. In the (2) polling method, completion of the operation by the ACC is immediately detected by performing busy polling (constantly monitoring a buffer in which data is stored when the operation is completed). Description thereof will be given in order.

FIG. 18 is an explanatory diagram of the above-described (1) interrupt method, and FIG. 19 is a schematic time-lapse diagram of the interrupt method illustrated in FIG. 18. In the description with reference to FIG. 18, the same components as those in FIG. 17 are denoted by the same reference signs.

As illustrated in FIG. 18, APL 1 requests ACC 12 to offload processing (see reference sign b in FIG. 18); and ACC 12 issues, by an interrupt (see reference sign c in FIG. 18), a notification (response) of completion of the operation.

As illustrated in FIG. 19, an application thread (CPU) requests ACC 12 to offload processing 1 being performed (see reference sign b in FIG. 19). The application thread (CPU) can perform other processing (here, processing 2) during the ACC offloading. As other processing can be performed while the processing is being offloaded to the ACC, high CPU utilization efficiency is achieved.

In the (1) interrupt method, APL 1 detects completion of the operation performed by the ACC via an interrupt (see reference sign c in FIG. 19). Due to the interrupt, the application thread (CPU) needs to suspend the in-progress processing (processing 2) and save intermediate data. In this case, the application thread (CPU) performs, by the interrupt, post-processing (e.g., forward error correction (FEC) processing) of the processing 1 and then performs the in-progress processing (continuation of the processing 2). This raises the concern of an increase in the processing time caused by the interrupt processing overhead.

FIG. 20 is an explanatory diagram for explaining the (2) polling method. FIG. 21 is a schematic time-lapse diagram of the polling method illustrated in FIG. 20. In the description with reference to FIG. 20, the same components as those in FIG. 18 are denoted by the same reference signs.

As illustrated in FIG. 20, APL 1 requests ACC 12 to offload processing (see reference sign d in FIG. 20). APL 1 performs busy polling (constantly monitors a buffer in which data is stored when the ACC completes the operation) (see reference sign e in FIG. 20). With this, APL 1 immediately detects the completion (response) of the operation by ACC 12 (see reference sign f in FIG. 20).

As illustrated in FIG. 21, the application thread (CPU) requests ACC 12 to offload processing 1 being performed (see reference sign d in FIG. 21). The application thread (CPU) continues busy polling during ACC offloading until an operation result from ACC 12 is received, without performing other processing. Due to this, CPU resources are wasted during the polling. However, the (2) polling method is capable of detecting the completion of the ACC processing at high speed by busy polling (see reference sign f in FIG. 21). After the completion of the ACC processing is detected at high speed, post-processing of the processing 1 is performed, and then the next processing (processing 2) is performed.

The advantages and disadvantages of the (1) interrupt method and the (2) polling method as methods of acquiring the operation result of the ACC in ACC offloading are summarized as follows:

The (1) interrupt method has the advantage of achieving a high CPU utilization efficiency but has the concern of an increase in the processing time due to an interrupt processing overhead.

The (2) polling method has the advantage of detecting completion of the operation by the ACC at high speed by busy polling but has the concern of an increase in the power consumption due to wasteful use of CPU resources during the polling and a decrease in the CPU resource efficiency.

The present invention has been made in view of such a background, and an object of the present invention is to reduce the processing time and improve the CPU utilization efficiency.

### Solution to Problem

In order to achieve the above-described object, an accelerator offload device that offloads specific processing of an application program to an accelerator includes: a request-related processing part; a request I/O part; a response I/O part; and a response-related processing part, wherein the request-related processing part is configured to perform predetermined processing required before performing offloading to the accelerator and then notify the request I/O part of a request to perform offloading, wherein the request I/O part is configured to operate on a first CPU core to perform request processing of notifying the accelerator of an offload request, wherein the response I/O part is configured to operate on a second CPU core different from the first CPU core to perform response processing of notifying the response-related processing part of operation completion of the accelerator; and wherein the response-related processing part is configured to perform an operation described in the application program by using an operation result of the accelerator.

### Advantageous Effects of Invention

The present invention can reduce the processing time and improve the CPU utilization efficiency.

### BRIEF DESCRIPTION OF DRAWINGS

FIG. 1 is a schematic configuration diagram of an accelerator offload system according to a first embodiment of the present invention.

FIG. 2 is a schematic time-lapse diagram illustrating an overview of an operation of an accelerator offload device of the accelerator offload system according to the first embodiment of the present invention.

FIG. 3 is a flowchart illustrating a <Preparation Phase> by a management part of the accelerator offload device of the accelerator offload system according to the first embodiment of the present invention.

FIG. 4 is a flowchart illustrating <Request-Side Processing> of the accelerator offload device of the accelerator offload system according to the first embodiment of the present invention.

FIG. 5 is a flowchart illustrating <Response-Side Processing> of the accelerator offload device of the accelerator offload system according to the first embodiment of the present invention.

FIG. 6 is an explanatory diagram illustrating an example of task allocation by a task scheduler of the accelerator offload device of the accelerator offload system according to the first embodiment of the present invention.

FIG. 7 is a schematic configuration diagram of a modification example of the accelerator offload system according to the first embodiment of the present invention.

FIG. 8 is a schematic time-lapse diagram illustrating an overview of an operation of an accelerator offload device of the modification example of the accelerator offload system according to the first embodiment of the present invention.

FIG. 9 is a schematic configuration diagram of an accelerator offload system according to a second embodiment of the present invention.

FIG. 10 is a schematic time-lapse diagram illustrating an overview of an operation of an accelerator offload device of the accelerator offload system according to the second embodiment of the present invention.

FIG. 11 is a flowchart illustrating a <Preparation Phase> by a management part of the accelerator offload device of the accelerator offload system according to the second embodiment of the present invention.

FIG. 12 is a flowchart illustrating <Task Scheduler Processing/Request-Side Processing> of the accelerator offload device of the accelerator offload system according to the second embodiment of the present invention.

FIG. 13 is a flowchart illustrating <Response-Side Processing> of the accelerator offload device of the accelerator offload system according to the second embodiment of the present invention.

FIG. 14 is a hardware configuration diagram illustrating an example of a computer that implements the function of the accelerator offload device of the accelerator offload system according to the second embodiment of the present invention.

FIG. 15 illustrates an example in which an accelerator offload system is applied to an interrupt model in a server virtualized environment configured with a general-purpose Linux kernel and a VM.

FIG. 16 illustrates an example in which an accelerator offload system is applied to an interrupt model in a server virtualized environment configured with a container.

FIG. 17 is a schematic diagram illustrating processing of offloading part of the processing operated by a CPU to an accelerator (ACC).

FIG. 18 is an explanatory diagram illustrating an interrupt method.

FIG. 19 is a schematic time-lapse diagram of the interrupt method in FIG. 18.

FIG. 20 is an explanatory diagram illustrating a polling method.

FIG. 21 is a schematic time-lapse diagram of the polling method in FIG. 20.

### DESCRIPTION OF EMBODIMENTS

Hereinafter, an accelerator offload system and the like in a mode for carrying out the present invention (hereinafter, referred to as “present embodiment”) will be described with reference to the drawings.

### First Embodiment

### [Overall Configuration]

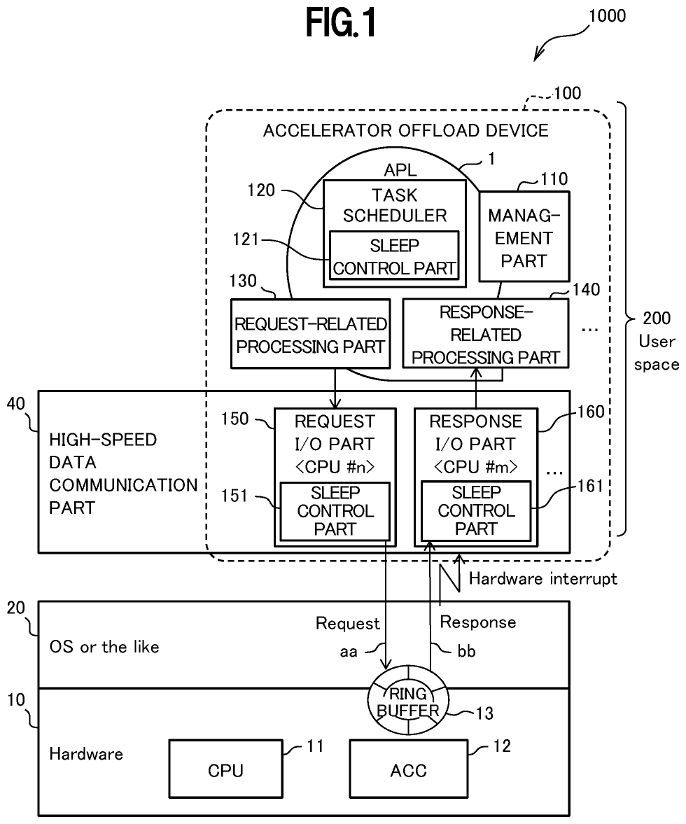

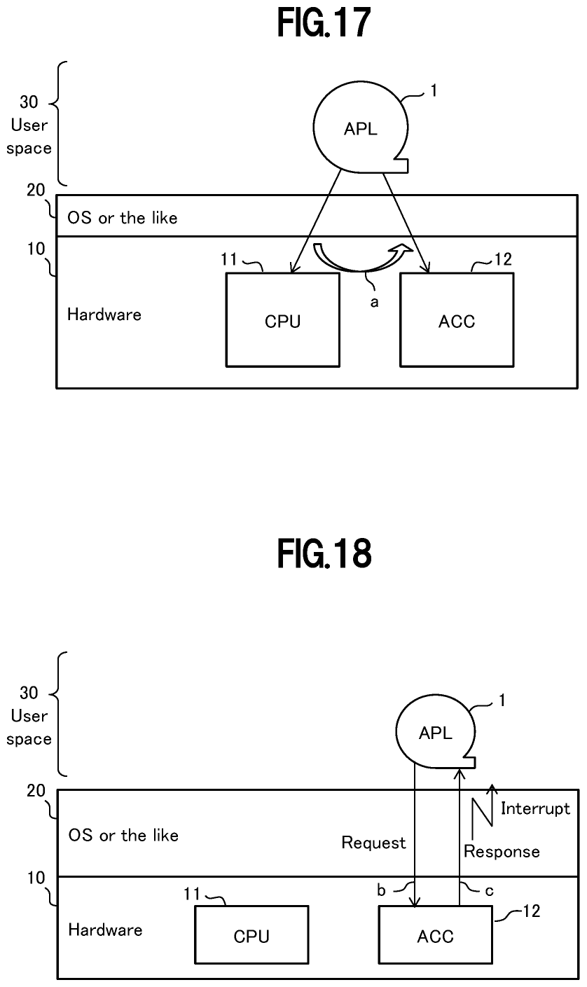

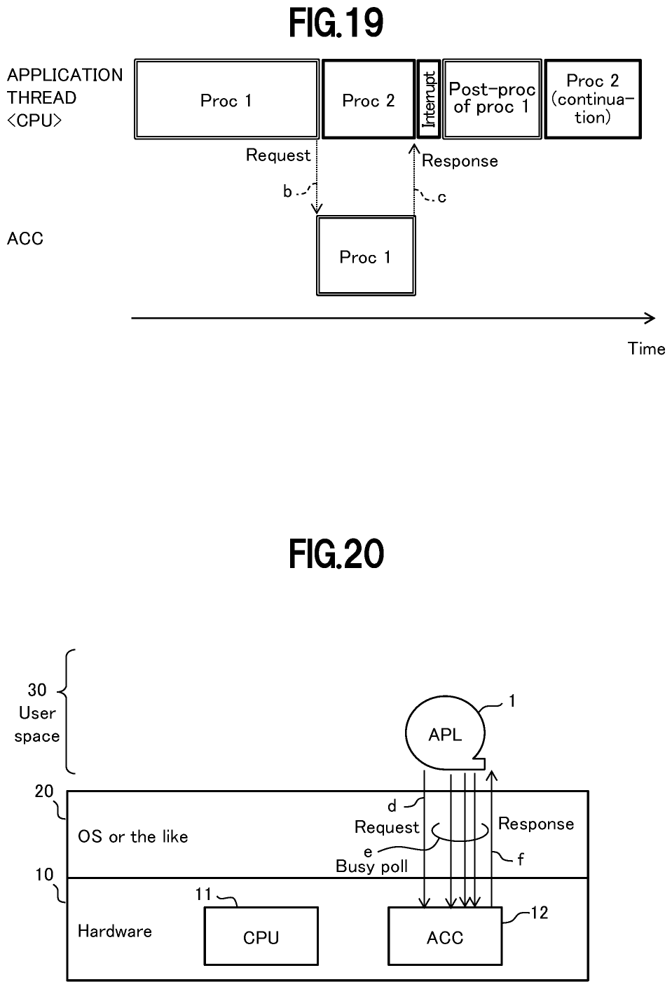

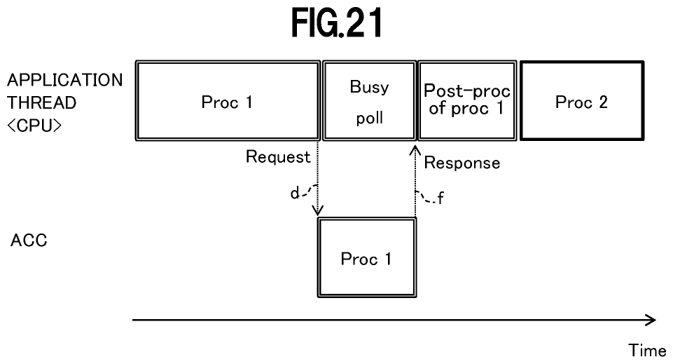

FIG. 1 is a schematic configuration diagram of an accelerator offload system according to a first embodiment of the present invention. The same components as those in FIG. 17 are denoted by the same reference signs.

As illustrated in FIG. 1, an accelerator offload system 1000 includes hardware (HW) 10, an OS or the like 20, a high-speed data communication part 40 that is high-speed data transfer middleware deployed in a user space 200, an accelerator offload device 100, and an APL 1. Hardware 10 includes a CPU 11, an accelerator (ACC) 12, and a ring buffer 13.

ACC 12 is computing unit hardware that performs specific operation based on an input from CPU 11 at high speed. Specifically, accelerator 12 is a GPU or a PLD such as an FPGA.

Ring buffer 13 is provided in hardware 10 and copies a workload to be processed. A request I/O part 150 and a response I/O part 160 exchange data with the accelerator via ring buffer 13.

An application (APL) 1 (application program) is further deployed in user space 200. APL 1 is a program executed by an application thread (CPU) in user space 200.

### [Accelerator Offload Device 100]

Accelerator offload device 100 includes a management part 110, a task scheduler 120, a request-related processing part 130, a response-related processing part 140, a request I/O part (CPU #n) 150, and a response I/O part (CPU #m) 160. Task scheduler 120 includes a sleep control part 121. Request I/O part (CPU #n) 150 includes a sleep control part 151. Response I/O part (CPU #m) 160 includes a sleep control part 161.

In the following description, “sleep” means that the CPU executes a command having a small number of cycles, such as a pause command.

The notations of CPU #n and CPU #m (n and m are any natural numbers) represents use of different CPU cores.

Accelerator offload device 100 is deployed in user space 200. For example, request-related processing part 130 and response-related processing part 140 are implemented in APL 1, and request I/O part (CPU #n) 150 and response I/O part (CPU #m) 160 are implemented in high-speed data communication part 40 described later (as a library of a high-speed data communication layer configured with CUDA, OpenCL BBDEV API, and the like).

Note that request I/O part (CPU #n) 150 and response I/O part (CPU #m) 160 may be included and implemented in request-related processing part 130 and response-related processing part 140, respectively, in APL 1.

### <Management Part 110>

Management part 110 manages a CPU core group composed of a plurality of CPU cores. Management part 110 determines a CPU core to be used by request-related processing part 130, response-related processing part 140, request I/O part 150, or response I/O part 160 from among the CPU core group.

Management part 110 allocates one CPU core to response I/O part 160 as a response-dedicated functional part from among the CPU core group.

Management part 110 secures, in advance, a CPU core group that may be used by the functional parts (request-related processing part 130, response-related processing part 140, request I/O part (CPU #n) 150, and response I/O part (CPU #m) 160). Here, an operator may determine how to use the CPU cores in advance such that another application does not use the CPU core group.

Management part 110 determines, for each of the functional parts (request-related processing part 130, response-related processing part 140, request I/O part (CPU #n) 150, and response I/O part (CPU #m) 160), a CPU core to be used by the functional part from among the CPU core group.

### <Task Scheduler 120>

When a task that needs to be offloaded to the accelerator occurs, task scheduler 120 registers the task in a task queue of request-related processing part 130. Task scheduler 120 registers the task as a task using a CPU core different from the CPU core used by response I/O part 160.

Task scheduler 120 includes a sleep control part configured to, when no task is to be operated on a CPU, cause a thread running on the CPU to sleep.
A case where a task that needs to be offloaded to ACC 12 occurs

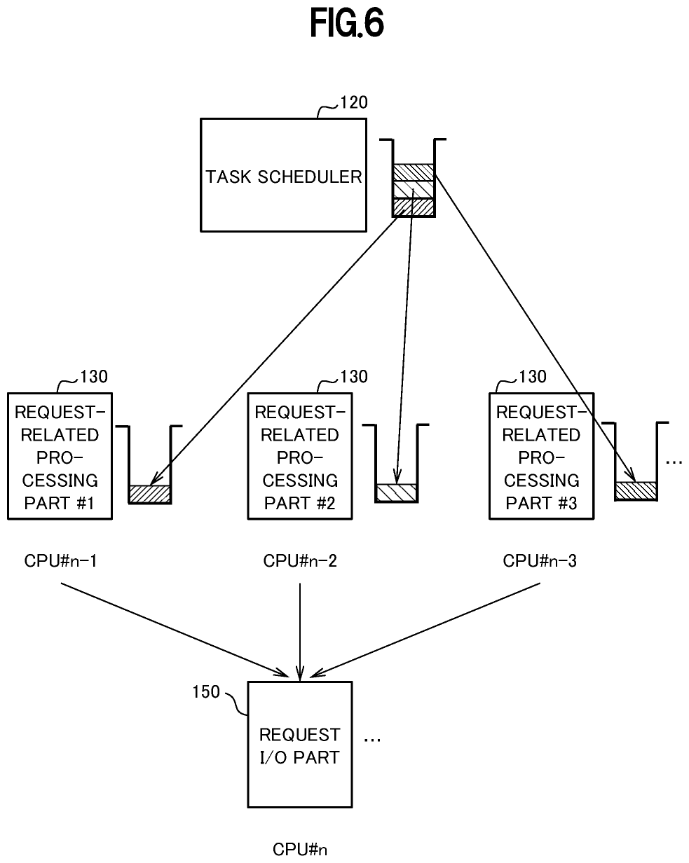

When a task that needs to be offloaded to ACC 12 occurs, task scheduler 120 registers the task in the task queue of request-related processing part 130 (see FIG. 6 described later for a task distribution image). At this time, task scheduler 120 registers the task as a task using a CPU core different from the CPU core used by response I/O part (CPU #m) 160. When request-related processing part 130 is sleeping, sleep control part 121 of task scheduler 120 wakes up request-related processing part 130.

Further, when the CPU operating frequency of CPU core #n used by each of the processing parts has lowered, task scheduler 120 increases the CPU operating frequency, and, when the CPU idle state is in the power saving mode, task scheduler 120 causes a transition to the non-power saving mode.
A case where a notification of an offload request has been made to ACC 12

Sleep control part 121 of task scheduler 120 causes request-related processing part 130 to sleep. At this time, for further power saving, the CPU operating frequency of CPU core #n being used may be lowered, and the CPU idle state may be set to the power saving mode.

### <Request-Related Processing Part 130>

Request-related processing part 130 performs a series of processing (predetermined processing) required before offloading to the accelerator. The series of processing required before offloading to the accelerator will be described later.

Request-related processing part 130 performs the series of processing required before ACC offloading and then notifies request I/O part (CPU #n) 150 of a request to perform ACC offloading. Note that when request I/O part 150 and request-related processing part 130 use different CPU cores, sleep control part 121 of task scheduler 120 may cause request I/O part 150 to sleep at this timing.

### <Response-Related Processing Part 140>

Response-related processing part 140 performs operations described in the application program by using the operation result of ACC 12.

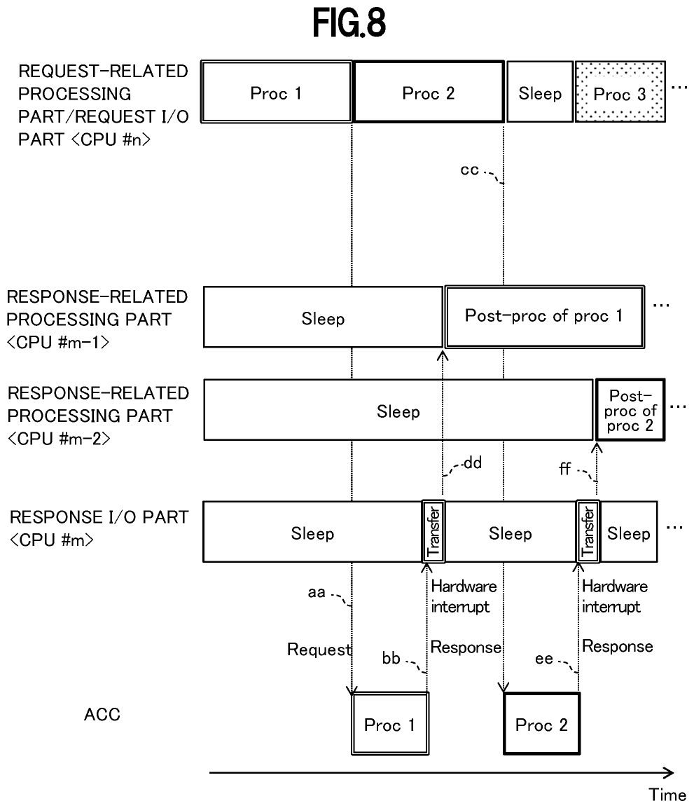

Response-related processing part 140 performs the operations described in APL 1 by using the operation result of ACC 12. Response-related processing part 140 may perform the processing by CPU core #m used by response I/O part (CPU #m) 160 or may perform the processing by another core (FIG. 8 described later).

### <Series of Processing Required Before ACC Offloading>

The series of processing required before ACC offloading will be described.

A description will be given taking an example where encoding processing of FEC in a vRAN or virtual DU (vDU) is offloaded to ACC 12.

### [Uplink Processing]

Request-related processing part 130 performs mapping, equivalent processing, inverse discrete Fourier transform (IDFT), channel estimation, demodulation, and descrambling in resource elements.

Response-related processing part 140 performs frame processing (transmission processing of an Ethernet frame or the like).

### [Downlink Processing]

Request-related processing part 130 performs frame processing (reception processing of an Ethernet frame or the like).

Response-related processing part 140 performs scrambling, modulation, layer mapping, precoding, and resource element mapping.

### <Request I/O Part (CPU #n) 150>

Request I/O part (CPU #n) 150 is composed of a CPU core and performs request processing of issuing an offload request to ACC 12.

Request I/O part (CPU #n) 150 issues an offload request to ACC 12. At this time, request I/O part (CPU #n) 150 copies via ring buffer 13 a workload to be processed.

### <Response I/O Part (CPU #m) 160>

Response I/O part (CPU #m) 160 is composed of a CPU core different from the CPU core and performs response processing of notifying response-related processing part 140 of operation completion of the accelerator.

Response I/O part (CPU #m) 160 wakes up upon receipt of an interrupt. At this time, when the CPU operating frequency of CPU core #m used by response I/O part 160 has lowered, task scheduler 120 increases the CPU operating frequency, and, when the CPU idle state is in the power saving mode, task scheduler 120 causes a transition to the non-power saving mode.

Response I/O part (CPU #m) 160 notifies response-related processing part 140 that ACC 12 has completed the operation to communicate pointer information on an area of ring buffer 13 where the operation result is stored.

### [High-Speed Data Communication Part 40]

High-speed data communication part 40 is a high-speed data communication layer configured with CUDA, OpenCL BBDEV API, and the like. For example, high-speed data communication part 40 is CUDA Toolkit (registered trademark) for using a GPU manufactured by NVIDIA (registered trademark) or OpenCL (registered trademark) for operation using a heterogeneous processor. In addition, BBDEV API (registered trademark) provides an accelerator I/O function for processing wireless access signals as a development kit (library).

High-speed data communication part 40 incorporates the accelerator I/O function provided as libraries by above-described CUDA, OpenCL, BBDEV API, or the like into APL 1 in user space 200, thereby allowing APL 1 to have the accelerator I/O function for processing wireless access signals.

Hereinafter, a description will be given of an operation of accelerator offload device 100 of the accelerator offload system 1000 configured as described above.

### (Description of Principle)

### (1) Reduction in Interrupt Overhead

The present invention uses CPU cores separate for request processing and for response processing in order to avoid an interrupt overhead caused by the save processing in the interrupt method. In the present embodiment, accelerator offload device 100 includes a CPU core for request processing (request-related processing part 130 and request I/O part 150) and a CPU core for response processing (response-related processing part 140 and response I/O part 160). In other words, accelerator offload device 100 provides (allocates) at least one of a plurality of CPU cores as a CPU core that is a response-dedicated functional part (response-related processing part 140 and response I/O part 160).

As the CPU core for response processing (response-dedicated functional part) is provided, a state where no in-progress processing is present is maintained at the time of interruption to eliminate the save processing, thereby achieving low latency.

### (2) Power Saving

In order to reduce an increase in the power consumption caused by provision of the response-dedicated functional part, the present invention performs sleep control (including CPU operating frequency control and CPU idle state control) while there is no processing.

When there is no power saving processing, sleep is performed and the CPU operating frequency and the CPU idle state are controlled to reduce the power consumption to achieve power saving.

### (3) Reduction in Number of Memory Copies

Ring buffer 13, which can be referenced by both the high-speed data communication layer and an ACC, is provided for data communication between APL 1 and ACC 12. The I/O parts of high-speed data communication part 40 exchange data with ACC 12 via ring buffer 13, thereby reducing the number of memory copies between APL 1 and ACC 12. Reducing unnecessary memory copies achieves high-speed data communication.

### [Overview of Operation of Accelerator Offload Device 100]

As illustrated in FIG. 1, APL 1 requests request-related processing part 130 of accelerator offload device 100 to offload processing. Request-related processing part 130 performs series of processing required before ACC offloading and then notifies request I/O part (CPU #n) 150 of a request to perform ACC offloading. Request I/O part (CPU #n) 150 notifies ACC 12 of an offload request (see reference sign aa in FIG. 1). At this time, request I/O part (CPU #n) 150 copies via ring buffer 13 a workload to be processed.

ACC 12 operates the offloaded workload, then notifies, by a hardware interrupt, response I/O part (CPU #m) 160 that the operation has been completed (see reference sign bb in FIG. 1) and stores the operation result in ring buffer 13. At this time, as the destination of the hardware interrupt, a CPU core (response I/O part (CPU #m) 160), which is different from the CPU core (request I/O part (CPU #n) 150) used by request-related processing part 130, is designated.

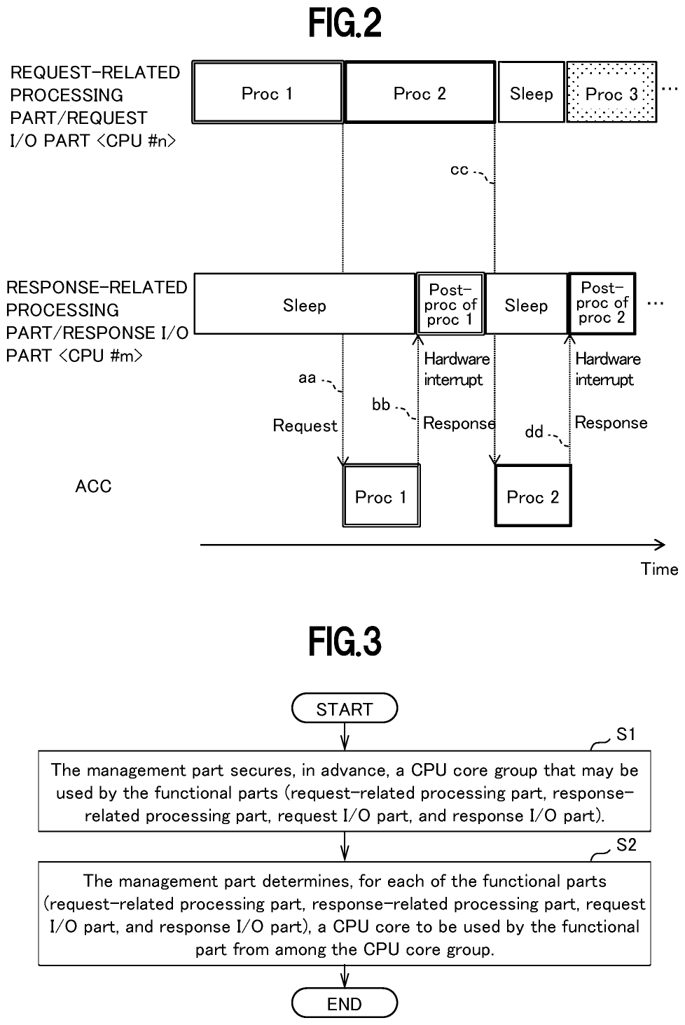

FIG. 2 is a schematic time-lapse diagram illustrating an overview of an operation of accelerator offload device 100 illustrated in FIG. 1.

As illustrated in FIG. 2, request-related processing part 130 and request I/O part (CPU #n) 150 request ACC 12 to offload processing 1 being performed by the application thread (CPU) (see reference sign aa in FIG. 1). The application thread (CPU) can perform other processing (here, processing 2) during ACC offloading. As the other processing can be performed while offloading to ACC is being performed, high CPU utilization efficiency, which is the advantage of the conventional (1) interrupt method, will be enjoyed.

At this time, as response-related processing part 140 and response I/O part (CPU #m) 160 perform no processing (are not involved in the request-related processing), response-related processing part 140 and response I/O part (CPU #m) 160 perform sleep control (including CPU operating frequency control and CPU idle state control) while performing no processing. By performing sleep control (including CPU operating frequency control and CPU idle state control), power saving is achieved.

ACC 12 operates the offloaded workload and notifies, by a hardware interrupt (see reference sign bb in FIG. 2), response I/O part (CPU #m) 160 that the operation has been completed. That is, response I/O part (CPU #m) 160, which is the CPU core (response-dedicated functional part) for response processing, detects the completion of the operation by ACC 12, via the interrupt. Response-related processing part 140 and response I/O part (CPU #m) 160 wake up in response to the hardware interrupt. Response-related processing part 140 and response I/O part (CPU #m) 160 perform post-processing of the processing 1 in response to the interrupt without suspending the in-progress processing (processing 2) (because request-related processing part 130 and request I/O part (CPU #n) 150 are exclusively performing that processing) and perform sleep control after the post-processing of the processing 1.

The reason why response-related processing part 140 and response I/O part (CPU #m) 160 can immediately perform the post-processing of the processing 1 in response to the interrupt is that request-related processing part 130 and request I/O part (CPU #n) 150 exclusively complete the processing 2. Response-related processing part 140 and response I/O part (CPU #m) 160 perform sleep control until waking up in response to the next hardware interrupt.

As the in-progress processing is not suspended by an interrupt and there is no need of saving intermediate data (concern of the conventional (1) interrupt method), it is possible to reduce the interrupt overhead by avoiding the save processing.

At this time, as request-related processing part 130 and request I/O part (CPU #n) 150 are not involved in the response-related processing (the processing is exclusively performed by response-related processing part 140 and response I/O part (CPU #m) 160), the application thread (CPU) can request ACC 12 to offload the next processing (processing 2) (see reference sign cc in FIG. 2). The application thread (CPU) can perform other processing during ACC offloading. However, in this case, as there is no processing, sleep control is performed on the application thread. As request-related processing part 130 and request I/O part (CPU #n) 150 achieve power saving by performing sleep control.

The reason why the in-progress processing is not suspended by the interrupt is that the response-related processing is exclusively performed by response-related processing part 140 and response I/O part (CPU #m) 160 and the resources therefor are allocated to request-related processing part 130 and request I/O part (CPU #n) 150, thereby increasing the efficiency of request-related processing part 130 and request I/O part (CPU #n) 150.

Response I/O part (CPU #m) 160 detects the completion of the operation by ACC 12 via an interrupt (see reference sign dd in FIG. 2). Response-related processing part 140 and response I/O part (CPU #m) 160 wake up in response to the hardware interrupt. Response-related processing part 140 and response I/O part (CPU #m) 160 perform post-processing of the processing 2 in response to the interrupt.

### [Flowchart]

An operation of accelerator offload device 100 will be described with reference to the flowcharts illustrated in FIGS. 3 to 5.

### <Preparation Phase>

FIG. 3 is a flowchart illustrating a <Preparation Phase> by management part 110 of accelerator offload device 100.

In step S1, management part 110 (FIG. 1) of accelerator offload device 100 secures, in advance, a CPU core group that may be used by the functional parts (request-related processing part 130, response-related processing part 140, request I/O part (CPU #n) 150, and response I/O part (CPU #m) 160). Here, the operator may determine how to use the CPU cores in advance such that another application does not use the CPU core group.

In step S2, management part 110 determines, for each of the functional parts (request-related processing part 130, response-related processing part 140, request I/O part (CPU #n) 150, and response I/O part (CPU #m) 160), a CPU core to be used by the functional part from among the CPU core group and terminates the processing of the flow.

A description will be given of an example of determining the CPU core to be used by each functional part from among the CPU core group.

For example, determination is made such that request-related processing part 130 use CPUs #n−a to #n−1, request I/O part 150 use CPU #n, response I/O part 160 use CPU #m, and response-related processing part 140 use CPUs #m−β to #m−1. The above a and B are constants. Depending on the heaviness of the processing by request-related processing part 130 and response-related processing part 140, the number of CPU cores usable by request-related processing part 130 and response-related processing part 140 is set to be large by increasing a and b when the processing is heavy.

### <Request-Side Processing>

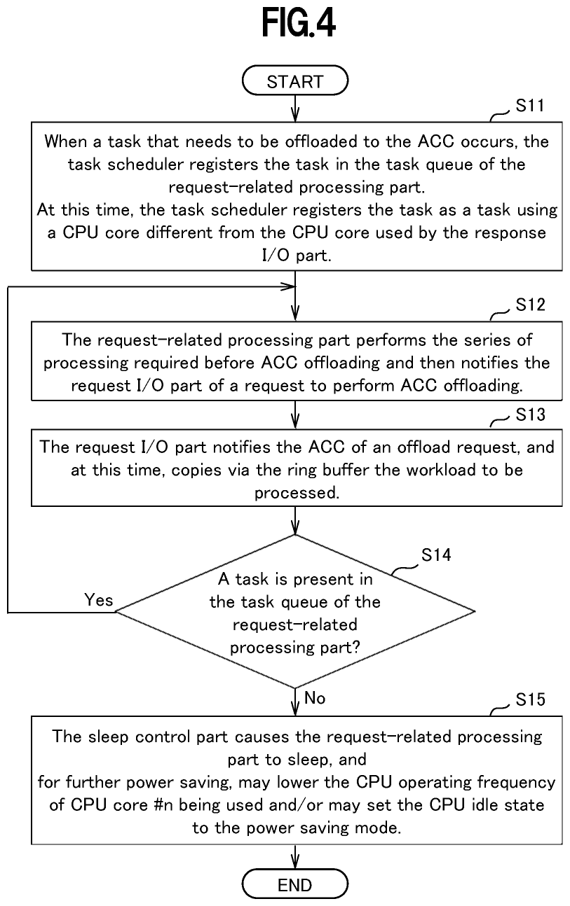

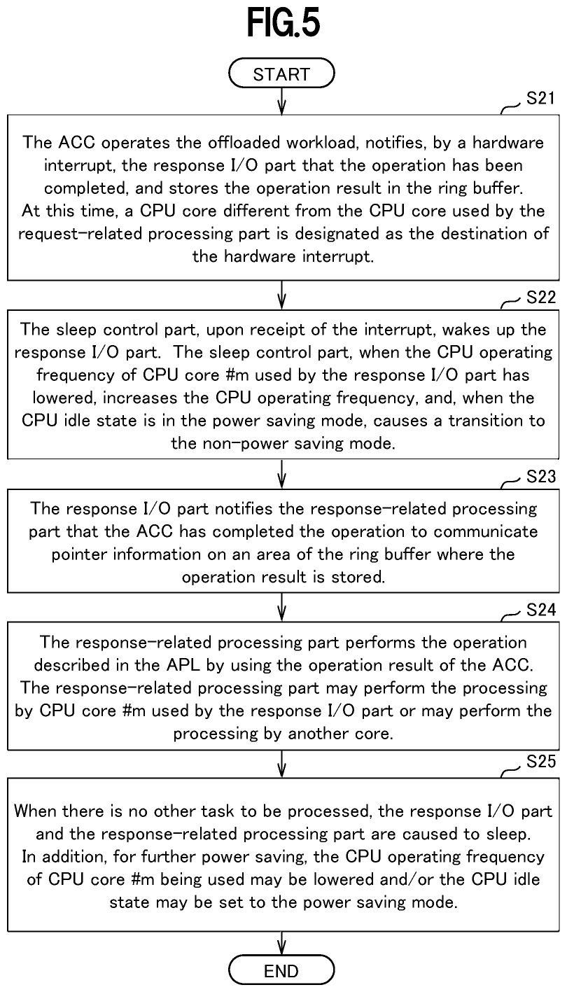

FIGS. 4 and 5 are flowcharts illustrating an <Actual Processing Phase> of accelerator offload device 100. The <Actual Processing Phase> includes <Request-Side Processing> illustrated in FIG. 4 and <Response-Side Processing> illustrated in FIG. 5.

FIG. 4 is a flowchart illustrating the <Request-Side Processing> of accelerator offload device 100.

In step S11, when a task that needs to be offloaded to the ACC occurs, task scheduler 120 (FIG. 1) of accelerator offload device 100 registers the task in the task queue of request-related processing part 130 (see FIG. 6 described later for a task distribution image).

At this time, task scheduler 120 registers the task as a task using a CPU core different from the CPU core used by response I/O part 160.

Here, when request-related processing part 130 (FIG. 1) is sleeping, task scheduler 120 wakes up request-related processing part 130.

In addition, when the CPU operating frequency of CPU core #n used by a processing part has lowered, task scheduler 120 increases the CPU operating frequency, and, when the CPU idle state is in the power saving mode, task scheduler 120 causes a transition to the non-power saving mode.

In step S12, request-related processing part 130 of accelerator offload device 100 performs the series of processing required before ACC offloading and then notifies request I/O part 150 of a request to perform ACC offloading.

Here, when request I/O part 150 and request-related processing part 130 use different CPU cores, request-related processing part 130 may cause request-related processing part 130 to sleep at this timing.

In step S13, request I/O part 150 (FIG. 1) of accelerator offload device 100 notifies ACC 12 of an offload request (copies the target workload via ring buffer 13 at this time). The processing transitions to the <Response-Side Processing> (FIG. 5).

In step S14, request I/O part (CPU #n) 150 determines whether a task is present in the task queue of request-related processing part 130.

When no task is present in the task queue of request-related processing part 130 (S14: No), in step S15, sleep control part 151 of request I/O part (CPU #n) 150 causes request-related processing part 130 to sleep and terminates the processing of the flow.

At this time, for further power saving, the CPU operating frequency of CPU core #n being used may be lowered, and the CPU idle state may be set to the power saving mode.

When a task is present in the task queue of request-related processing part 130 (S14: Yes), the processing proceeds to step S12.

### <Response-Side Processing>

FIG. 5 is a flowchart illustrating the <Response-Side Processing> of accelerator offload device 100.

In step S21, ACC 12 (FIG. 1) operates the offloaded workload, notifies, by a hardware interrupt, response I/O part 160 that the operation has been completed and stores the operation result in ring buffer 13. At this time, a CPU core different from the CPU core used by request-related processing part 130 is designated as the destination of the hardware interrupt.

When the processing to be performed by response-related processing part 140 is heavy and new ACC offloading processing is completed before the processing of response-related processing part 140 is completed, a hardware interrupt may be raised to a different CPU core, and request I/O part 150 and request-related processing part 130 may be multi-threaded to perform the processing.

When the frequency of the interrupt increases/decreases, scaling out/in may be achieved by changing the interrupt destination CPU core.

In step S22, sleep control part 161 (FIG. 1) of response I/O part (CPU #m) 160, upon receipt of the interrupt, wakes up response I/O part (CPU #m) 160. Sleep control part 161, when the CPU operating frequency of CPU core #m used by response I/O part (CPU #m) 160 has lowered, increases the CPU operating frequency, and, when the CPU idle state is in the power saving mode, causes a transition to the non-power saving mode.

In step S23, response I/O part (CPU #m) 160 of accelerator offload device 100 notifies response-related processing part 140 that the ACC has completed the operation to communicate pointer information on an area of ring buffer 13 where the operation result is stored.

When request I/O part (CPU #n) 150 and request-related processing part 130 use different CPU cores, request I/O part 150 may be caused to sleep at this timing.

In step S24, response-related processing part 140 performs the operation described in APL 1 by using the operation result of ACC 12.

Here, response-related processing part 140 may perform the processing by CPU core #m used by response I/O part (CPU #m) 160 or may perform the processing by another core (see FIG. 8 described later).

In step S25, when there is no other task to be processed, sleep control part 121 of task scheduler 120 causes response I/O part (CPU #m) 160 and response-related processing part 140 to sleep and terminates the processing of the flow.

For further power saving, sleep control part 121 may lower the CPU operating frequency of CPU core #m being used and/or may set the CPU idle state to the power saving mode.

Here, the sleep control, CPU operating frequency setting, and CPU idle state setting of response I/O part 160 may be performed in step S23 described above.

### [Task Allocation Example of Task Scheduler 120]

A description will be given of a task allocation example of task scheduler 120.

FIG. 6 is an explanatory diagram illustrating an example of the task allocation by task scheduler 120. In the drawing, basket-shaped images on the sides of task scheduler 120 and request-related processing parts 130 each schematically represent a task queue. In the task queue, tasks to be offloaded to ACC 12 are schematically illustrated.

Task scheduler 120 distributes (schedules) tasks according to the availabilities of the task queues of the request-related processing parts 130. At this time, round robin may be used, or the tasks may be distributed in the ascending order of the number of remaining tasks of the request-related processing parts 130.

When tasks are registered in the plurality of request-related processing parts 130 at the same time, the plurality of request-related processing parts 130 may possibly complete the tasks at the same time and the processing may possibly be communicated to request I/O part (CPU #n) 150 at the same time; and further, when there is a plurality of ACC offloading operation processors, the ACC offloading processing may possibly be completed at the same time and hardware interrupts to response I/O part (CPU #m) 160 may possibly occur at the same time, and thus the hardware interrupts may occur in the middle of the processing by response I/O part (CPU #m) 160. In view of this, it is conceivable to intentionally shift the timings of distributing the tasks from task scheduler 120 to the request-related processing parts 130.

[Example of Case where Post-Response Processing is Heavy]

A description will be given of an example of a case where post-response processing is heavy.

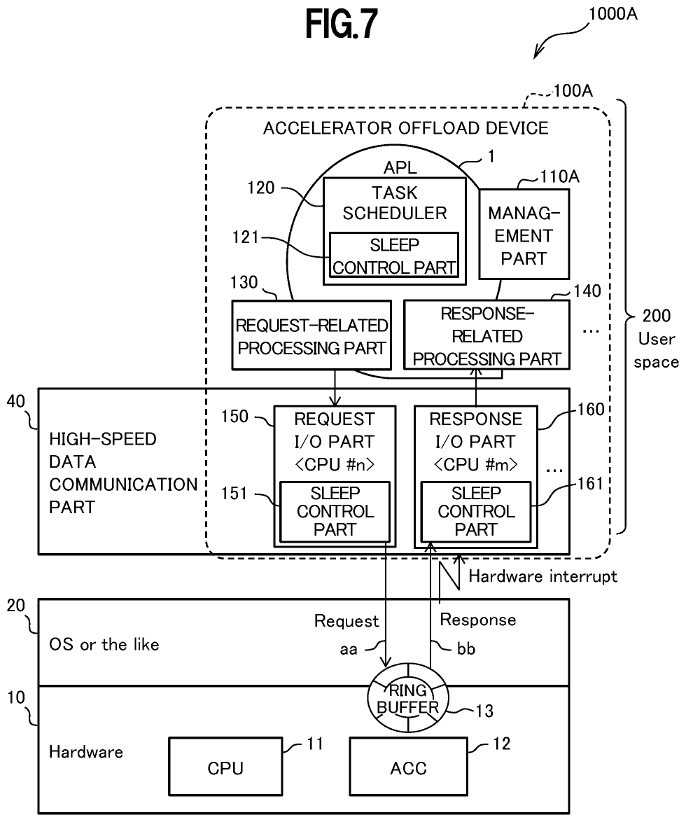

FIG. 7 is a schematic configuration diagram of a modification example of the accelerator offload system according to the first embodiment of the present invention. FIG. 7 is a schematic configuration diagram of the accelerator offload system in a case where the post-response processing is heavy. The same components as those in FIG. 1 are denoted by the same reference signs, and description thereof is omitted.

As illustrated in FIG. 7, an accelerator offload system 1000A includes an accelerator offload device 100A.

Accelerator offload device 100A includes a management part 110A, task scheduler 120, request-related processing part 130, response-related processing part 140, request I/O part (CPU #n) 150, and response I/O part (CPU #m) 160.

Management part 110A has, in addition to the function (see FIG. 3) of management part 110 of accelerator offload device 100 in FIG. 1, a function of allocating a plurality of CPU cores to response-related processing part 140.

Hereinafter, a description will be given of an operation of accelerator offload device 100A of accelerator offload system 1000A configured as described above.

FIG. 8 is a schematic time-lapse diagram illustrating an overview of an operation of accelerator offload device 100A in FIG. 7.

As illustrated in FIG. 8, when the post-processing by response-related processing part 140 is heavy and takes a long time, a hardware interrupt may possibly be inputted from ACC 12 when the response-related processing part 140 is performing the post processing, so that an interrupt overhead such as memory saving may occur (see reference signs ee and ff in FIG. 8). Examples where the post-processing by response-related processing part 140 is heavy include a case where response I/O part 160 and response-related processing part 140 use the same CPU core.

In accelerator offload device 100A illustrated in FIG. 7, management part 110A allocates a plurality of CPU cores to response-related processing parts 140 in the <Preparation Phase> illustrated in FIG. 3. In FIG. 8, a plurality of CPU cores (CPU #m−1 and CPU #m−2) are allocated to response-related processing parts 140.

Response I/O part (CPU #m) 160 concentrates on receiving (mediating) hardware interrupts from ACC 12, and upon receipt of a hardware interrupt (see reference sign bb in FIG. 8), response I/O part (CPU #m) 160 transfers post-processing (post-processing of the processing 1) to response-related processing part (CPU #m−1) 140 (see reference sign dd in FIG. 8). Response-related processing part (CPU #m−1) 140 exclusively performs the transferred post-processing (post-processing of the processing 1). Assuming that the post-processing (post-processing of the processing 1) takes a long time, response-related processing part (CPU #m−1) 140 does not (cannot) perform other processing.

At this time, as request-related processing part 130 and request I/O part (CPU #n) 150 are not involved in the response-related processing (the processing is exclusively performed by response-related processing part 140 and response I/O part (CPU #m) 160), the application thread (CPU) can request ACC 12 to offload the next processing (processing 2) (see reference sign cc in FIG. 8).

Response I/O part (CPU #m) 160 concentrates on receiving (mediating) hardware interrupts from ACC 12, and upon receipt of a hardware interrupt (see reference sign ee in FIG. 8), response I/O part (CPU #m) 160 transfers the post-processing (post-processing of the processing 2) to response-related processing part (CPU #m−2) 140 (see reference sign ff in FIG. 8). Response-related processing part (CPU #m−2) 140 exclusively performs the transferred post-processing (post-processing of the processing 2). At this time, response-related processing part (CPU #m−1) 140 is exclusively performing the (post-processing of the processing 1).

FIG. 8 illustrates an example where the post-processing is transferred from response-related processing part (CPU #m−1) 140 to response-related processing part (CPU #m−2) 140. However, the post-processing may be transferred by using a load balancer to a response-related processing part 140 set in the load balancer.

With this, accelerator offload device 100A can avoid a state where, when a hardware interrupt occurs, response I/O part (CPU #m) 160 that receives the hardware interrupt is performing other processing.

### Second Embodiment

In the case of the first embodiment, a mode in which the request-related processing and the response-related processing are performed by different threads (different CPU cores) is illustrated. It is also conceivable of a mode in which request and response processing are performed by the same thread (CPU core). This mode will be described as a second embodiment.

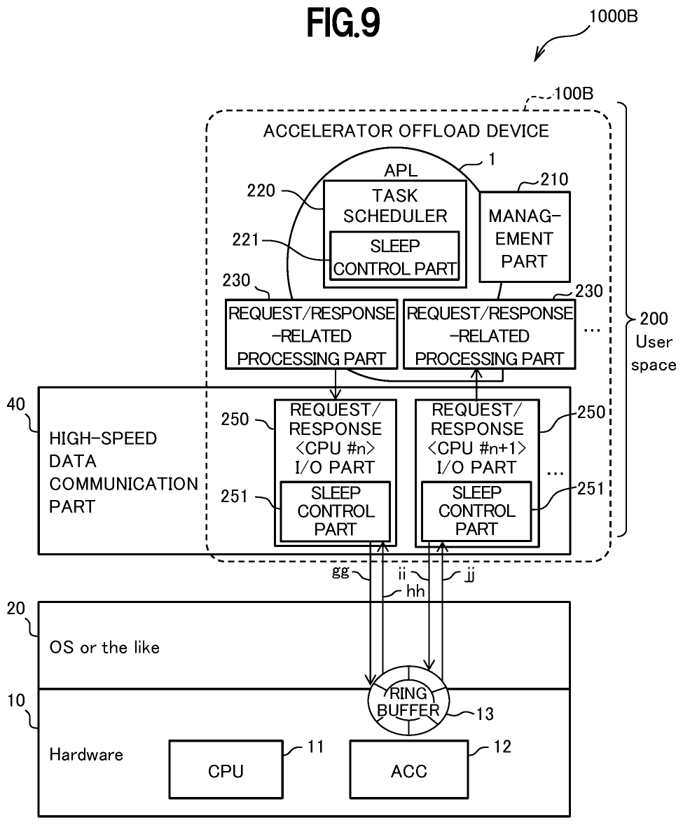

FIG. 9 is a schematic configuration diagram of an accelerator offload system according to the second embodiment of the present invention. The same components as those in FIG. 1 are denoted by the same reference signs, and description thereof is omitted.

As illustrated in FIG. 9, an accelerator offload system 1000B includes an accelerator offload device 100B.

Accelerator offload device 100B includes a management part 210, a task scheduler 220, request/response-related processing parts 230 (request-related processing parts 230 and response-related processing parts 230), and request/response I/O parts 250 (request/response I/O part (CPU #n) 250 and request/response I/O part (CPU #n+1) 250).

Request/response I/O part (CPU #n) and request/response I/O part (CPU #n+1) have the same configuration, and thus the same number is given to request/response I/O part (CPU #n) 250 and request/response I/O part (CPU #n+1) 250.

Task scheduler 220 includes a sleep control part 221. Request/response I/O part (CPU #n) and request/response I/O part (CPU #n+1) 250 each include a sleep control part 251.

Management part 210 secures, in advance, a CPU core group that may be used by functional parts (request/response-related processing parts 230, request/response I/O part (CPU #n) 250, and request/response I/O part (CPU #n+1) 250). Here, the operator may determine how to use the CPU cores in advance such that another application does not use the CPU core group.

Management part 210 determines, for each of the functional parts (request/response-related processing parts 230, request/response I/O part (CPU #n) 250, and request/response I/O part (CPU #n+1) 250), a CPU core to be used by the functional part.

When a task that needs to be offloaded to ACC 12 occurs, task scheduler 220 registers the task in the task queue of a request/response-related processing part 230 (see FIG. 6 for a task distribution image).

Task scheduler 220 allocates tasks to a plurality of CPU cores in a distributed manner taking into account the timings of receiving the operation results from ACC 12. In order to maintain a state where no in-progress processing is present when a hardware interrupt for receiving the processing result from ACC 12 is generated, task scheduler 220 registers the task as a task using request/response I/O part (CPU #n+1) 250 that uses a CPU core different from the CPU core used by request/response I/O part (CPU #n) 250. When the request-related processing part 230 is sleeping, sleep control part 221 of task scheduler 220 wakes up the request-related processing part 230.

The request/response-related processing part 230 performs the series of processing required before ACC offloading and then notifies a request/response I/O part 250 (request/response I/O part (CPU #n) 250 or request/response I/O part (CPU #n+1) 250) of a request to perform ACC offloading.

The Request/response I/O part 250 (request/response I/O part (CPU #n) 250 or request/response I/O part (CPU #n+1) 250) notifies ACC 12 of an offload request. At this time, the Request/response I/O part 250 (request/response I/O part (CPU #n) 250 or request/response I/O part (CPU #n+1) 250) copies via ring buffer 13 a workload to be processed.

A request/response I/O part 250 (request/response I/O part (CPU #n) 250 or request/response I/O part (CPU #n+1) 250) wakes up in response to an interrupt. At this time, when the CPU operating frequency of CPU core #n or #n+1 used by the request/response I/O part 250 (request/response I/O part (CPU #n) 250 or request/response I/O part (CPU #n+1) 250) has lowered, task scheduler 220 increases the CPU operating frequency, and when the CPU idle state is in the power saving mode, task scheduler 220 causes a transition to the non-power saving mode.

The request/response I/O part 250 (request/response I/O part (CPU #n) 250 or request/response I/O part (CPU #n+1) 250) notifies a request/response-related processing part 230 that ACC 12 has completed the operation to communicate pointer information on an area of ring buffer 13 where the operation result is stored.

Hereinafter, an operation of accelerator offload device 100B of accelerator offload system 1000B configured as described above will be described.

Task scheduler 220 illustrated in FIG. 9 allocates tasks in a distributed manner to a plurality of CPU cores taking into account the timings of receiving the operation results from ACC 12. For example, task scheduler 220 allocates the processing 1 to CPU #n and allocates the processing 2 to CPU #n+1, a CPU core different from CPU #n.

Task scheduler 220 allocates tasks in a distributed manner to a plurality of CPU cores in order to maintain a state where no in-progress processing is present when a hardware interrupt for receiving the processing result from the ACC is generated. Here, the processing 1 is handled by request/response I/O part (CPU #n) 250, and the processing 2 is handled by request/response I/O part (CPU #n+1) 250.

As illustrated in FIG. 9, APL 1 requests a request/response-related processing part 230 of accelerator offload device 100B to offload processing (processing 1). The request/response-related processing part 230 performs the series of processing required before ACC offloading and then notifies request/response I/O part (CPU #n) 250 of a request to perform ACC offloading. Request/response I/O part (CPU #n) 250 notifies ACC 12 of an offload request (see reference sign gg in FIG. 9). At this time, request/response I/O part (CPU #n) 250 copies via ring buffer 13 a workload to be processed.

ACC 12 operates the offloaded workload, notifies, by a hardware interrupt, request/response I/O part (CPU #n) 250 that ACC 12 has completed the operation (see reference sign hh in FIG. 9) and stores the operation result in ring buffer 13.

Task scheduler 220 allocates tasks to a plurality of CPU cores in a distributed manner taking into account the timings of receiving the operation results from ACC 12. In order to maintain a state where no in-progress processing is present when a hardware interrupt for receiving the processing result from ACC 12 is generated, task scheduler 120 registers the task as a task using request/response I/O part (CPU #n+1) 250.

APL 1 requests a request/response-related processing part 230 of accelerator offload device 100B to offload the next processing (processing 2). The request/response-related processing part 230 performs the series of processing required before ACC offloading and then notifies request/response I/O part (CPU #n+1) 250 of a request to perform ACC offloading. Request/response I/O part (CPU #n+1) 250 notifies ACC 12 of an offload request (see reference sign ii in FIG. 9). At this time, request/response I/O part (CPU #n+1) 250 copies via ring buffer 13 a workload to be processed.

ACC 12 operates the offloaded workload, then notifies, by a hardware interrupt, request/response I/O part (CPU #n+1) 250 that the operation has been completed (see reference sign jj in FIG. 9) and stores the operation result in ring buffer 13.

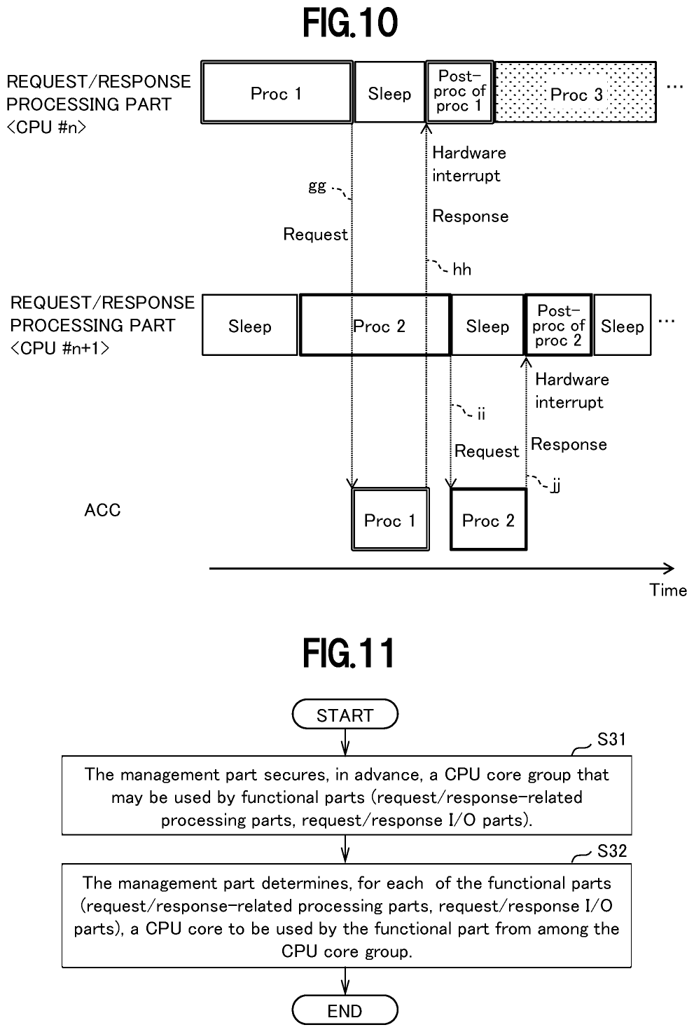

FIG. 10 is a schematic time-lapse diagram illustrating an overview of an operation of accelerator offload device 100B illustrated in FIG. 9.

Task scheduler 220 registers a task as a task using request/response I/O part (CPU #n) 250.

As illustrated in FIG. 10, a request-related processing part 230 and request/response I/O part (CPU #n) 250 request ACC 12 to offload processing 1 being performed by the application thread (CPU) (see reference sign gg in FIG. 10). The application thread (CPU) can execute other processing (here, processing 2) during ACC offloading.

At this time, as the request-related processing part 230 and request/response I/O part (CPU #n) 250 perform no processing (are not involved in the request-related processing), the request-related processing part 230 and request/response I/O part (CPU #n) 250 perform sleep control (including CPU operating frequency control and CPU idle state control) while performing no processing.

ACC 12 operates the offloaded workload and notifies, by a hardware interrupt, request/response I/O part (CPU #n) 250 that the operation has been completed (see reference sign hh in FIG. 10). The request-related processing part 230 and request/response I/O part (CPU #n) 250 wake up in response to the hardware interrupt. In response to the interrupt, the request-related processing part 230/request/response I/O part (CPU #n) 250 performs post-processing of the processing 1 and performs the next processing (processing 3) after the post-processing of the processing 1.

In order to maintain a state where no in-progress processing is present when a hardware interrupt receiving the processing result from ACC 12 is generated, task scheduler 220 registers a task as a task using request/response I/O part (CPU #n+1) 250 that uses a CPU core different from CPU #n.

APL 1 requests a request-related processing part 230 of accelerator offload device 100B to offload a next processing (processing 2) (see reference sign ii in FIG. 10). The application thread (CPU) can execute other processing (here, processing 3) during ACC offloading. The processing 3 is to be handled by request/response I/O part (CPU #n) 250.

At this time, because the request-related processing part 230 and request/response I/O part (CPU #n+1) 250 perform no processing (are not involved in the request-related processing), the request-related processing part 230 and request/response I/O part (CPU #n+1) 250 perform sleep control (including CPU operating frequency control and CPU idle state control) while performing no processing.

ACC 12 operates the offloaded workload and notifies, by a hardware interrupt, request/response I/O part (CPU #n+1) 250 that the operation has been completed (see reference sign jj in FIG. 10). The request-related processing part 230 and request/response I/O part (CPU #n+1) 250 wake up in response to the hardware interrupt. In response to the interrupt, the request-related processing part 230/request/response I/O part (CPU #n+1) 250 performs the post-processing of the processing 2 and performs sleep control after the post-processing of the processing 2.

The first embodiment illustrates a mode in which the request-related processing and the response-related processing are performed by different threads (different CPU cores). In this case, in order to maintain a state where no in-progress processing is present when a hardware interrupt for receiving the processing result from the ACC is generated, task scheduler 120 (FIG. 1) allocates tasks to a plurality of CPU cores in a distributed manner taking into account the timings of receiving the operation results from the ACC. CPU #n needs to wait until the result of the processing 1 is returned from the ACC, and thus the CPU cannot be used for other processing 2, 3, . . . during this period. Therefore, the CPU resource efficiency may possibly deteriorate. On the other hand, it is possible to securely create a sleep state at the time of receiving the response. Thus, no contention with another task occurs at the time of receiving the response, and thus it is unnecessary to perform scheduling processing or the like for avoiding the contention. Therefore, there is an advantage that the implementation of the application can be simplified.

Accelerator offload device 100B according to the present embodiment includes: task scheduler 220 that allocates tasks to a plurality of CPU cores in a distributed manner taking into account the timings of receiving the operation results from ACC 12; and request/response-related processing parts 230, request/response I/O part (CPU #n) 250, request/response I/O part (CPU #n+1) 250, which perform request and response processing in the same thread (CPU core).

This makes it possible to prevent the CPU resource efficiency from deteriorating for the reason the CPU cannot be used for other processing.

### [Flowchart]

An operation of accelerator offload device 100B will be described with reference to the flowcharts illustrated in FIGS. 11 to 13.

### <Preparation Phase>

FIG. 11 is a flowchart illustrating a <Preparation Phase> by management part 210 of accelerator offload device 100B.

In step S31, management part 210 (FIG. 9) of accelerator offload device 100B secures, in advance, a CPU core group that may be used by functional parts (request/response-related processing parts 230, request/response I/O part (CPU #n) 250, request/response I/O part (CPU #n+1) 250). Here, the operator may determine how to use the CPU cores in advance such that another application does not use the CPU core group.

In step S32, management part 210 determines CPU cores to be used by request/response-related processing parts 230, request/response I/O part (CPU #n) 250, and request/response I/O part (CPU #n+1) 250 from among the CPU core group and terminates the processing of the flow.

An example of determining the CPU core to be used by each functional part from among the CPU core group will be described.

For example, determination is made such that request/response-related processing parts 230 use CPUs #n−a to #n−1, request/response I/O part (CPU #n) 250 use CPU #n, and request/response I/O part (CPU #n+1) 250 use CPU #n+1. The above a is a constant. Depending on the heaviness of the processing, the number of CPU cores usable by request/response-related processing parts 230 is set to be large by increasing a when the processing is heavy.

### <Task Scheduler Processing/Request-Side Processing>

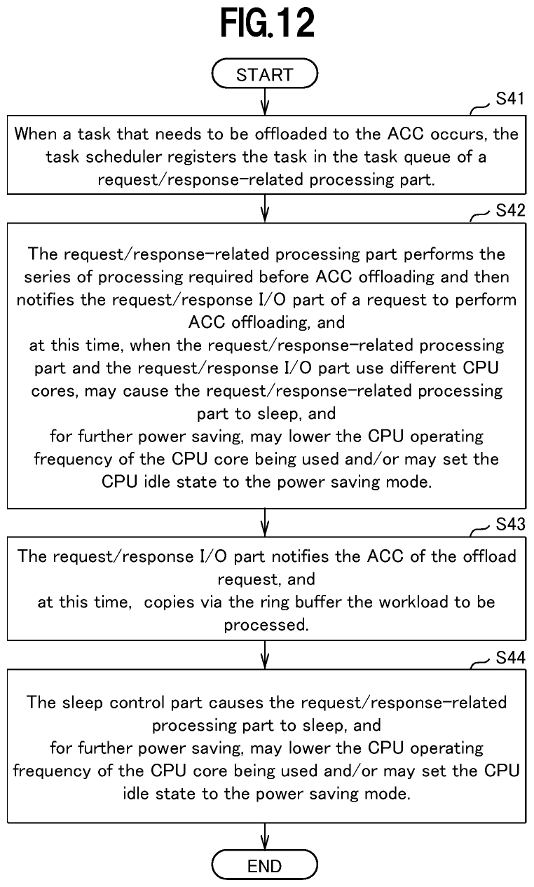

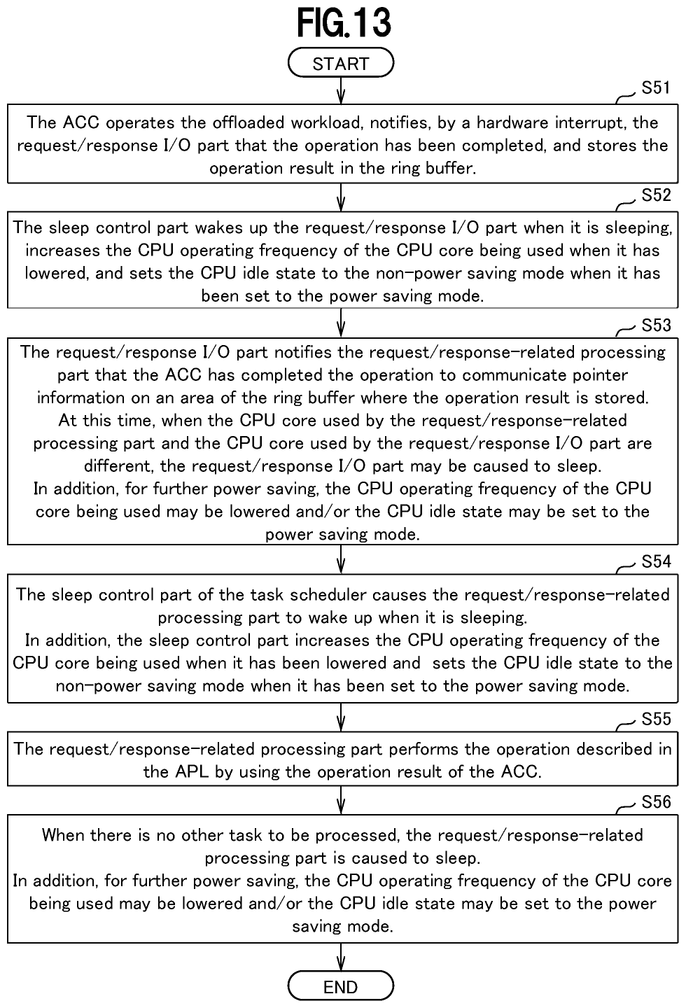

FIGS. 12 and 13 are flowcharts illustrating an <Actual Processing Phase> of accelerator offload device 100B. The <Actual Processing Phase> includes <Task Scheduler Processing/Request-Side Processing> in FIG. 12 and <Response-Side Processing> in FIG. 13.

FIG. 12 is a flowchart illustrating the <Task Scheduler Processing/Request-Side Processing> of accelerator offload device 100B.

In step S41, when a task that needs to be offloaded to the ACC occurs, task scheduler 220 (FIG. 9) of accelerator offload device 100B registers the task in the task queue of a request/response-related processing part 230 (see FIG. 6 for a task distribution image).

Task scheduler 220 allocates tasks to a plurality of CPU cores in a distributed manner taking into account the timings of receiving the operation results from ACC 12.

Here, when the request/response-related processing part 230 (FIG. 9) is sleeping, task scheduler 220 wakes up the request/response-related processing part 230.

When the CPU operating frequency of the CPU core used by each processing part has lowered, task scheduler 220 increases the CPU operating frequency, and when the CPU idle state is in the power saving mode, task scheduler 220 causes a transition to the non-power saving mode.

In step S42, the request/response-related processing part 230 of accelerator offload device 100B performs the series of processing required before ACC offloading and then notifies the request/response I/O part 250 of a request to perform ACC offloading.

Here, when the request/response I/O part 250 (request/response I/O part (CPU #n) 250 or request/response I/O part (CPU #n+1) 250) uses a different CPU core, the request/response-related processing part 230 may be caused to sleep at this timing. Further, for further power saving, the CPU operating frequency of the CPU core being used may be lowered, and/or the CPU idle state may be set to the power saving mode.

In step S43, the request/response I/O part 250 (request/response I/O part (CPU #n) 250 or request/response I/O part (CPU #n+1) 250) of accelerator offload device 100B notifies ACC 12 of an offload request (at this time, the request/response I/O part 250 copies via ring buffer 13 a workload to be processed). The processing transitions to the <Response-Side Processing> (FIG. 13).

In step S44, sleep control part 251 of the request/response I/O part 250 (request/response I/O part (CPU #n) 250 or request/response I/O part (CPU #n+1) 250) causes the request/response-related processing part 230 to sleep and terminates the processing of the flow.

At this time, for further power saving, the CPU operating frequency of the CPU core being used may be lowered, and/or the CPU idle state may be set to the power saving mode.

### <Response-Side Processing>

FIG. 13 is a flowchart illustrating the <Response-Side Processing> in accelerator offload device 100B.

In step S51, ACC 12 (FIG. 9) operates the offloaded workload, notifies, by a hardware interrupt, the request/response I/O part 250 that the operation has been completed and stores the operation result in ring buffer 13.

In step S52, in a case where the request/response I/O part 250 (request/response I/O part (CPU #n) 250 or request/response I/O part (CPU #n+1) 250) is sleeping, sleep control part 251 of the request/response I/O part 250 wakes up the request/response I/O part 250.

When the CPU operating frequency of the CPU core to be used has lowered, sleep control part 251 increases the CPU operating frequency, and when the CPU idle state is in the power saving mode, sleep control part 251 causes a transition to the non-power saving mode.

In step S53, the request/response I/O part 250 (request/response I/O part (CPU #n) 250 or request/response I/O part (CPU #n+1) 250) notifies the request/response-related processing part 230 that ACC 12 has completed the operation to communicate pointer information on an area of ring buffer 13 where the operation result is stored.

At this time, when the CPU core used by the request/response-related processing part 230 and the CPU core used by the request/response I/O part 250 (request/response I/O part (CPU #n) 250 or request/response I/O part (CPU #n+1) 250) is different, the request/response I/O part 250 may be caused to sleep at this timing.

In addition, for further power saving, the CPU operating frequency of the CPU core being used may be lowered, and/or the CPU idle state may be set to the power saving mode.

In step S54, when the request/response-related processing part 230 is sleeping, the sleep control part 221 of task scheduler 220 wakes up the request/response-related processing part 230. In addition, when the CPU operating frequency of the CPU core being used has lowered, the sleep control part 221 increases the CPU operating frequency, and when the CPU idle state is in the power saving mode, the sleep control part 221 causes a transition to the non-power saving mode.

In step S55, the request/response-related processing part 230 performs the operation described in APL 1 by using the operation result of ACC 12.

In step S56, when there is no other task to be processed, sleep control part 221 of task scheduler 220 causes the request/response-related processing part 230 to sleep and terminates the processing of the flow.

In addition, for further power saving, the sleep control part 221 may lower the CPU operating frequency of the CPU core being used and/or may set the CPU idle state to the power saving mode.

### [Extended Function of Task Scheduler]

A description will be given of an extended function of the task scheduler.

In any of the first embodiment and the second embodiment, task scheduler 120 or 220 (FIG. 1, FIG. 9) may allocate tasks so as to maximize the sleep time of each CPU core such that the CPU core can sleep as long as possible. That is, in many cases, a CPU has a CPU idle state control function such as the C-state and can transition to a power saving state by controlling a voltage, a frequency, and the like by hardware control. This CPU idle state control function can cause the CPU to transition into a deeper sleep state the longer the time during which the CPU can sleep. This makes it possible to expect a further power saving effect by performing optimum allocation that maximizes the sleep time.

In order to avoid a state in which a certain thread is performing other processing when an operation result is received from ACC 12, the timing of receiving the operation result from ACC 12 may be machine-learned from past results and inferred, and scheduling may be performed by using the inference result. For example, in the FEC processing in a vRAN, the FEC processing time varies depending on a data size or error rate. By learning this, it is possible to estimate a time from transmission of a request to the ACC to acquisition of a response.

In any of the first embodiment and the second embodiment, task scheduler 120 or 220 (FIG. 1 or FIG. 9) may perform scheduling that increases the number of CPU cores to be used when the amount of the tasks increases (i.e. scaling out may be performed). In addition, when the amount of the tasks decreases, scheduling that reduces the number of CPU cores to be used may be performed (i.e., scaling in may be performed).

### [Hardware Configuration]

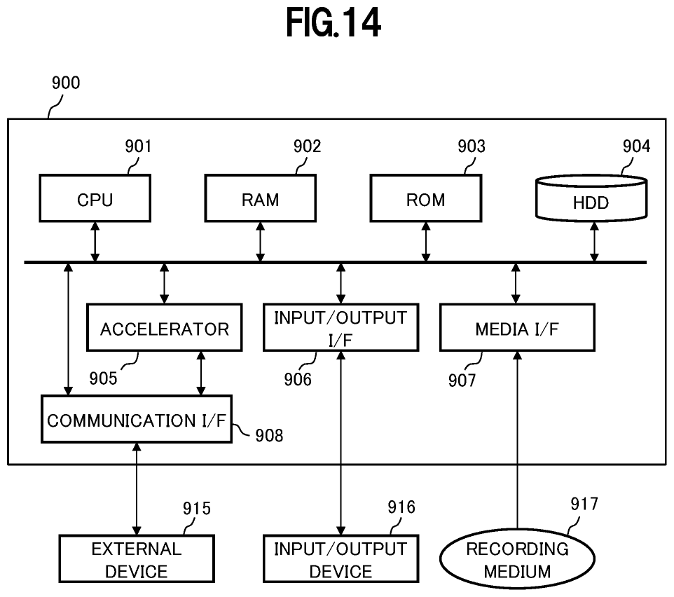

The accelerator offload devices 100, 100A, and 100B according to the above embodiments are implemented by a computer 900 having the configuration illustrated in FIG. 14, for example.

FIG. 14 is a hardware configuration diagram illustrating an example of computer 900 that implements functions of accelerator offload devices 100, 100A, and 100B.

Computer 900 includes a CPU 901, a RAM 902, a ROM 903, an HDD 904, an accelerator 905, an input/output interface (I/F) 906, a media interface (I/F) 907, and a communication interface (I/F) 908. Accelerator 905 corresponds to accelerator (ACC) 12 in FIGS. 1, 7, and 9.

Accelerator 905 is an accelerator (device) 12 (FIGS. 1, 7, and 9) that processes at least one of data from communication I/F 908 and data from RAM 902 at high speed. Accelerator 905 may be of a type (look-aside type) that performs processing from CPU 901 or RAM 902 and then returns the processing result to CPU 901 or RAM 902. On the other hand, accelerator 905 may also be of a type (in-line type) that is interposed between communication I/F 908 and CPU 901 or RAM 902 and performs the processing.

Accelerator 905 is connected to an external device 915 via communication I/F 908. Input/output I/F 906 is connected to an input/output device 916. Media I/F 907 reads/writes data from/to a recording medium 917.

CPU 901 operates according to a program stored in ROM 903 or HDD 904 and controls each component of accelerator offload devices 100, 100A, and 100B in FIGS. 1, 7, and 9 by executing the program (also referred to as an application or App as an abbreviation thereof) read into RAM 902. The program can be delivered via a communication line or delivered by being recorded in recording medium 917 such as a CD-ROM.

ROM 903 stores a boot program to be executed by CPU 901 when computer 900 is activated, a program that depends on the hardware of computer 900, and the like.

CPU 901 controls input/output device 916 including an input unit such as a mouse or a keyboard and an output unit such as a display or a printer via input/output I/F 906. CPU 901 acquires data from input/output device 916 and outputs generated data to input/output device 916 via input/output I/F 906. Note that a graphics processing unit (GPU) or the like may be used as a processor in conjunction with CPU 901.

HDD 904 stores a program to be executed by CPU 901, data to be used by the program, and the like. Communication I/F 908 receives data from another device via a communication network (e.g. network (NW)) and outputs the data to CPU 901 and also transmits data generated by CPU 901 to another device via the communication network.

Media I/F 907 reads a program or data stored in the recording medium 917 and outputs the program or data to the CPU 901 via the RAM 902. CPU 901 loads a program for the desired processing from recording medium 917 onto RAM 902 via media I/F 907 and executes the loaded program. Recording medium 917 is an optical recording medium such as a digital versatile disc (DVD) or a phase change rewritable disk (PD), a magneto-optical recording medium such as a magneto optical disk (MO), a magnetic recording medium, a conductor memory tape medium, a semiconductor memory, or the like.

For example, in a case where computer 900 functions as accelerator offload devices 100, 100A, or 100B configured as a device according to the present embodiment, CPU 901 of computer 900 implements the functions of accelerator offload devices 100, 100A, or 100B by executing the program loaded onto RAM 902. HDD 904 stores data in RAM 902. CPU 901 reads the program for the desired processing from recording medium 917 and executes the program. In addition, CPU 901 may read the program for the desired processing from another device via the communication network.

### [Application Examples]

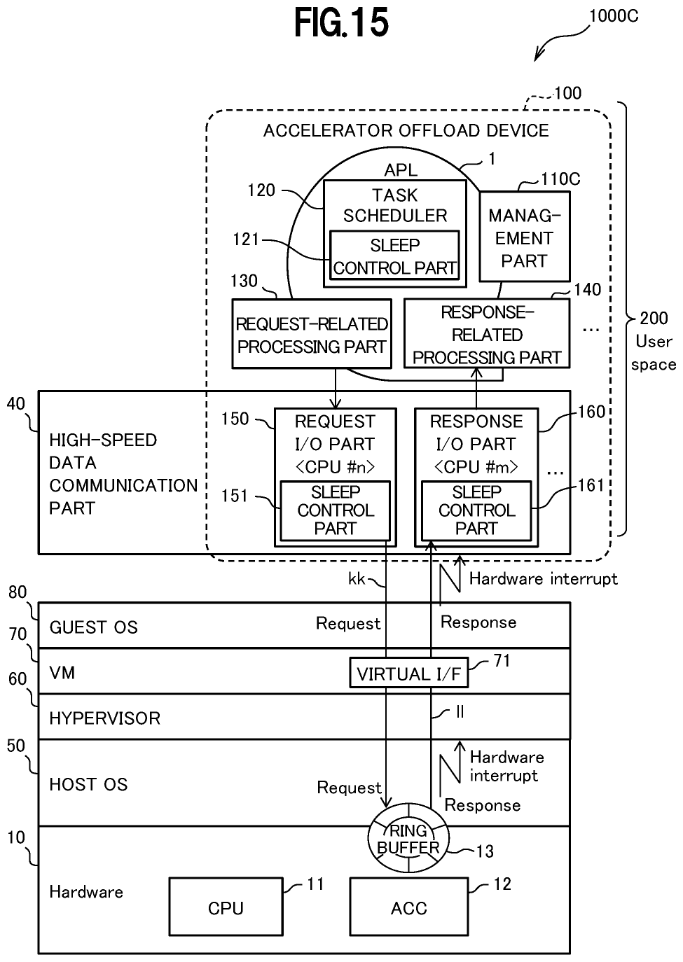

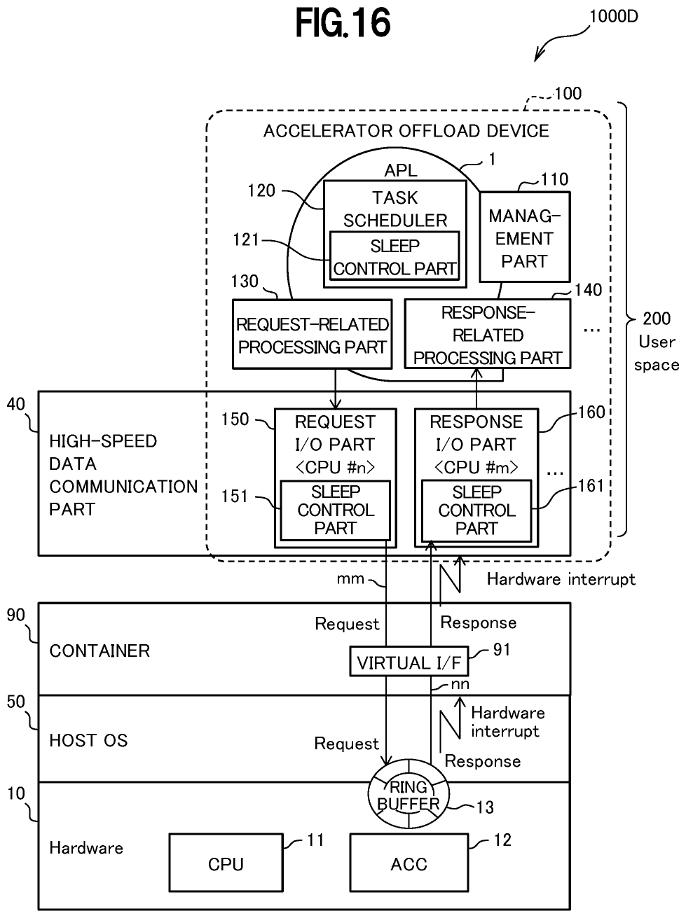

Accelerator offload devices 100, 100A, and 100B is to be deployed in user space 200, and the OS is not limited. In addition, they are not limited to being deployed under a server virtualized environment. Therefore, accelerator offload systems 1000 to 1000B can be applied to the configurations illustrated in FIGS. 15 and 16.

### <Example of Application to VM Configuration>

FIG. 15 illustrates an example where an accelerator offload system 1000C is applied to an interrupt model in a server virtualized environment configured with a general-purpose Linux kernel (registered trademark) and a VM. The same components as those in FIGS. 1, 7, and 9 are denoted by the same reference signs.

As illustrated in FIG. 15, accelerator offload system 1000C includes hardware (HW) 10, a host OS 50, a hypervisor 60, a VM 70, a guest OS 80, a high-speed data communication part 40 that is high-speed data transfer middleware deployed in a user space 200, and an accelerator offload device 100. Accelerator offload device 100 is merely an example and may be an accelerator offload device 100A or 100B (FIGS. 7 and 9).

Specifically, the server includes host OS 50 in which a virtual machine and an external process formed outside the virtual machine can operate, hypervisor 60, VM 70 having a virtual IF 71, and guest OS 80 operating in the virtual machine. Host OS 50 includes a ring buffer 13 managed by a kernel in a memory space in the server.

In accelerator offload system 1000C, accelerator offload device 100 is deployed in user space 200. Therefore, like DPDK, accelerator offload device 100 can reference a ring-structured buffer while bypassing the kernel. That is, accelerator offload device 100 does not use a ring buffer (ring buffer 13) or a pole list (not illustrated) in the kernel.

Accelerator offload device 100 can reference the ring-structured buffer (ring buffer 13) while bypassing the kernel and thus can instantly detect a packet arrival (i.e., polling model rather than interrupt model).

As illustrated in FIG. 15, a request-related processing part 130 and a request I/O part (CPU #n) 150 of accelerator offload device 100 request an ACC 12 to offload the processing 1 being performed by an application thread (CPU) via virtual IF 71 of VM 70 (see reference sign kk in FIG. 15). ACC 12 operates the offloaded workload and notifies, by a hardware interrupt, virtual IF 71 of VM 70 that the operation has been completed (see reference sign ll in FIG. 15). Virtual IF 71 of VM 70 notifies a response I/O part (CPU #m) 160 by a hardware interrupt. That is, by the interrupt, response I/O part (CPU #m) 160, a CPU core for response processing (response-dedicated functional part), detects the completion of the operation by ACC 12.

With this configuration, in both of host OS 50 and guest OS 80 in the system having the VM virtual server configuration, the notification interrupt of notifying of an ACC offloading result is applied to the notification to the APL 1 deployed in guest.

### <Example of Application to Container Configuration>

FIG. 16 illustrates an example where an accelerator offload system 1000D is applied to an interrupt model in a server virtualized environment configured with a container. The same components as those in FIG. 15 are denoted by the same reference signs.

As illustrated in FIG. 16, accelerator offload system 1000D has a container configuration in which guest OS 50 and the OS are replaced with a container 90. Container 90 includes a virtual IF 91. An accelerator offload device 100 is deployed in a user space 200.

As illustrated in FIG. 16, a request-related processing part 130 and a request I/O part (CPU #n) 150 of accelerator offload device 100 request an ACC 12 to offload the processing 1 being performed by an application thread (CPU) via virtual IF 91 of container 90 (see reference sign mm in FIG. 16). ACC 12 operates the offloaded workload and notifies, by a hardware interrupt, virtual IF 91 of container 90 that the operation has been completed (see reference sign nn in FIG. 16). The virtual IF 91 of the container 90 notifies a response I/O part (CPU #m) 160 by a hardware interrupt. That is, by the interrupt, response I/O part (CPU #m) 160, a CPU core for response processing (response-dedicated functional part), detects the completion of the operation by ACC 12.

With this configuration, in the system having the container configuration, the notification interrupt of notifying of an ACC offloading result is applied to the notification to an APL 1 deployed on the container.

### <Example of Application to Bare-Metal Configuration (Non-Virtualized Configuration)>

The present invention can be applied to a system having a non-virtualized configuration such as a bare-metal configuration (FIGS. 1, 7, and 9).

<CPU Pinning when Hyper-Threading is Used>

In a case of using the hyper-threading technique, which logically creates a plurality of CPU cores from a single physical CPU core, the cache hit rate may be improved by, for CPU cores #n1 and #n2 that are logical cores created on a physical CPU core #n, allocating request-related processing part 130 (FIG. 1) and request I/O part 150 (FIG. 1) to CPU core #n1 and allocating response-related processing part 140 (FIG. 1) and response I/O part 160 (FIG. 1) to CPU core #n2.

CPU cores #n1 and #n2 use the same physical CPU core and thus may share an L1 cache or L2 cache. In this case, when the request processing and response processing are allocated to use the same physical core, the cache hit rate can be improved in a case where there is data to be used in common in the request processing and the response processing.

### [Effects]

As described above, an accelerator offload device 100 that offloads specific processing of an application program (APL 1) to an accelerator (ACC 12) includes: a request-related processing part 130 configured to perform predetermined processing required before offloading to the accelerator and notify a request I/O part 150 of a request to perform offloading; request I/O part 150, composed of a CPU core and configured to perform request processing of notifying the accelerator of an offload request; a response I/O part 160 composed of a CPU core different from the CPU core and configured to perform response processing of notifying a response-related processing part 140 of operation completion of the accelerator; and response-related processing part 140, configured to perform an operation described in the application program by using an operation result of the accelerator.

With this configuration, when a workload that the CPU is not good at is offloaded to the ACC, it is possible to reduce the processing time (achieve low latency) and improve the CPU utilization efficiency by reducing the overhead caused by a hardware interrupt at the time of receiving the ACC operation result.

Accelerator offload device 100 further includes a management part 110 configured to manage a CPU core group composed of a plurality of CPU cores. Management part 110 is configured to determine a CPU core to be used by request-related processing part 130, response-related processing part 140, request I/O part 150, or response I/O part 160 from among the CPU core group.

With this configuration, the CPU utilization efficiency can be improved by determining the CPU core to be used by request-related processing part 130, response-related processing part 140, request I/O part 150, or the response I/O part 160 from among the CPU core group.

In accelerator offload device 100, management part 110 allocates one CPU core to response I/O part 160 as a response-dedicated functional part from among the CPU core group.

With this configuration, the CPU utilization efficiency can be improved by allocating the CPU core to at least response I/O part 160 as the response-dedicated functional part from among the CPU core group.

Accelerator offload device 100 further includes a task scheduler 120 configured to, when a task that needs to be offloaded to the accelerator (ACC 12) occurs, register the task in a task queue of request-related processing part 130, and task scheduler 120 registers the task as a task using a CPU core different from the CPU core used by response I/O part 160.

With this configuration, it is possible to prevent the CPU resource efficiency from deteriorating due to the CPU being unavailable for other processing. Further, it is possible to avoid a state in which, in a case where the post-response processing is heavy or when a hardware interrupt is generated, a response I/O part (CPU #m) 160 that is to receive the hardware interrupt is performing other processing. This makes it possible to reduce the processing time and improve the CPU utilization efficiency.

In accelerator offload device 100, task scheduler 120 includes a sleep control part configured to, when there is no task to be operated on a CPU, cause a thread running on the CPU to sleep.

With this configuration, it is possible to achieve high power saving by performing sleep when there is no processing. Further, by controlling the CPU operating frequency and the CPU idle state, higher power saving can be achieved.

An accelerator offload system 1000 is an accelerator offload system including an accelerator offload device that offloads specific processing of an application program to an accelerator. An accelerator offload device 100 is deployed in a user space 200. Hardware 10 including the accelerator (ACC 12) includes a ring buffer 13 that copies a workload to be processed. A request I/O part 150 and a response I/O part 160 exchange data with the accelerator via ring buffer 13.

With this configuration, the number of unnecessary memory copies in data communication between APL 1 and ACC 12 is reduced via ring buffer 13. This makes it possible to further reduce the processing time (achieve low latency) and improve the CPU utilization efficiency.

Note that, in the processing described in the above embodiments, all or some pieces of the processing described as those to be automatically performed may be manually performed, or all or some pieces of the processing described as those to be manually performed may be automatically performed by a known method. Further, processing procedures, control procedures, specific name, and information including various types of data and parameters described in the specification and the drawings can be freely changed unless otherwise specified.

The constituent elements of the devices illustrated in the drawings are functionally conceptual ones and are not necessarily physically configured as illustrated in the drawings. In other words, a specific form of distribution and integration of individual devices is not limited to the illustrated form, and all or part thereof can be functionally or physically distributed and integrated in any unit according to various loads, usage conditions, and the like.

Some or all of the configurations, functions, processing parts, processing means, and the like described above may be implemented by hardware by, for example, being designed in an integrated circuit. Each of the configurations, functions, and the like may be implemented by software for interpreting and executing a program for causing a processor to implement each function. Information such as a program, table, and file for implementing each function can be held in a recording device such as a memory, hard disk, or solid state drive (SSD) or a recording medium such as an integrated circuit (IC) card, secure digital (SD) card, or optical disc.

### REFERENCE SIGNS LIST

1 APL (application program)
10 Hardware
11 CPU
12 ACC (accelerator)
13 Ring buffer
40 High-speed data communication part
100, 100A, 100B Accelerator offload device
110, 210 management part
120, 220 Task scheduler
130 request-related processing part
140 response-related processing part
150 request I/O part (CPU #n)
160 response I/O part (CPU #m)
121, 151, 161, 221, 251 sleep control part
200 User space
230 Request/response-related processing part (request-related processing part, response-related processing part)
250 Request/response I/O part (CPU #n), request/response I/O part (CPU #n+1) (request I/O part, response I/O part)
1000 to 1000D Accelerator offload system

1. An accelerator offload device that offloads specific processing of an application program to an accelerator, the accelerator offload device comprising:
a request-related processing part
a request I/O part
a response I/O part; and
a response-related processing part,
wherein the request-related processing part is configured to perform predetermined processing required before performing offloading to the accelerator and then notify the request I/O part of a request to perform offloading;
wherein the request I/O part is configured to operate on a first CPU core to perform request processing of notifying the accelerator of an offload request;
wherein the response I/O part is configured to operate on a second CPU core different from the first CPU core to perform response processing of notifying the response-related processing part of operation completion of the accelerator; and
wherein the response-related processing part is configured to perform an operation described in the application program by using an operation result of the accelerator.

2. The accelerator offload device according to claim 1, further comprising a management part configured to manage a CPU core group composed of a plurality of CPU cores including the first CPU core and the second CPU core,
wherein the management part is configured to determine a CPU core to be used by the request-related processing part, the response-related processing part, the request I/O part, or the response I/O part from among the CPU core group.

3. The accelerator offload device according to claim 2,
wherein the response I/O part is a functional part dedicated to response processing, and
wherein the management part is further configured to exclusively allocate one of the plurality of CPU cores to the response I/O part as the second CPU core.

4. The accelerator offload device according to claim 1, further comprising a task scheduler configured to, when a task that needs to be offloaded to the accelerator occurs, register the task in a task queue of the request-related processing part,
wherein the task scheduler registers the task as a task using a third CPU core different from the second CPU core used by the response I/O part.

5. The accelerator offload device according to claim 4,
wherein the task scheduler comprises a sleep control part configured to, when there is no task to be operated on a CPU, cause a thread running on the CPU to sleep.

6. An accelerator offload system comprising an accelerator offload device configured to offload specific processing of an application program to an accelerator, the accelerator offload device deployed in a user space and comprising:
a request-related processing part
a request I/O part;
a response I/O part; and
a response-related processing part,
wherein the request-related processing part is configured to perform predetermined processing required before performing offloading to the accelerator and then notify the request I/O part of a request to perform offloading;
wherein the request I/O part is configured to operate on a first CPU core to perform request processing of notifying the accelerator of an offload request;
wherein the response I/O part is configured to operate on a second CPU core different from the first CPU core to perform response processing of notifying the response-related processing part of operation completion of the accelerator; and
wherein the response-related processing part is configured to perform an operation described in the application program by using an operation result of the accelerator.

7. The accelerator offload system according to claim 6,
wherein hardware including the accelerator includes a ring buffer that copies a workload to be processed, and
wherein the request I/O part and the response I/O part exchange data with the accelerator via the ring buffer.

8. An accelerator offload method of an accelerator offload device configured to offload specific processing of an application program to an accelerator, the accelerator offload method being performed by the accelerator offload device and comprising steps of:
performing predetermined processing required before performing offloading to the accelerator and then making a notification of a request to perform offloading;
performing, by using a first CPU core, request processing of notifying the accelerator of an offload request;
performing, by using a second CPU core different from the first CPU core, response processing of notifying of operation completion of the accelerator; and
performing an operation described in the application program by using an operation result of the accelerator.
